(19) United States
(12) Patent Application Publication
(10) Pub. No.: US 2010/0096546 A1
(43) Pub. Date: Apr. 22, 2010

(54) Solution Analysis Using Atmospheric Pressure Ionization Techniques

(75) Inventors: Kenneth J. Ewing, Elkridge, MD (US); Danielle N. Dickinson, Odenton, MD (US); Douglas B. Henderson, Columbia, MD (US); Johnny Ho, Clarksville, MD (US); Robert Milloy, Baltimore, MD (US)

Correspondence Address: ANDREWS KURTH LLP, 1350 I STREET, N.W., SUITE 1100, WASHINGTON, DC, 20005, US

(73) Assignee: Northrop Grumman Systems Corporation, Los Angeles, CA (US)

(21) Appl. No.: 12/643,801

(22) Filed: Dec. 21, 2009

Related U.S. Application Data
(63) Continuation-in-part of application No. 12/213,694, filed on Jun. 23, 2008.

(51) Int. Cl. B01D 59/44; H01J 49/00

(52) U.S. Cl. 250/282; 250/288; 250/287

(57) ABSTRACT

A chemical detection system is disclosed. The chemical detection system includes an atmospheric pressure ionization (API) source that produces an API stream, a sample delivery system that delivers a liquid sample in a continuous manner to the API stream, an ion detector capable of detecting a molecule of interest and a control device. Also disclosed is a method for detecting a chemical of interest in a liquid sample.

### RELATED APPLICATIONS

This application is a continuation-in-part application of U.S. patent application Ser. No. 12/213,694, filed on Jun. 23, 2008 which is incorporated herein by reference in its entirety.

### TECHNICAL FIELD

The embodiments described herein relate generally to chemical sample analysis systems, and more particularly, to a chemical sample analysis system using mass spectrometry coupled with atmospheric pressure ionization.

### BACKGROUND

Trace analysis of liquids is generally a labor intensive activity requiring proper sampling, sample handling, and sample preparation for analysis. In many cases the sample preparation is the most time consuming process requiring pre-concentration of analyte from the liquid or from the headspace above a liquid. For example, the state of the art analytical approach for detecting and quantifying organic compounds in solution is Solid Phase MicroExtraction, or SPME method. In this methodology, a thin silica fiber whose tip is porous and coated with a sorbent material is inserted into the solution. The SPME fiber is allowed to equilibrate with the solution during which time analytes are concentrated into the SPME fiber tip. After pre-concentration, the SPME fiber is inserted into a gas chromatography-Mass Spectrometer (GC/MS) for analysis. SPME requires time for the analyte to equilibrate with the SPME fiber. SPME also does not collect particulate contaminants. Other water analysis techniques, such as solid phase extraction (SPE), require specialized laboratory filtration approaches and solvents to extract and concentrate the preconcentrated analyte from the SPM membrane. Therefore, there exists a need for devices that are capable of analyzing liquid samples in real time with no or minimal sample pretreatment.

### SUMMARY

A chemical detection system is disclosed. The chemical detection system includes an atmospheric pressure ionization (API) source that produces an API stream, a sample delivery system that delivers a liquid sample in a continuous manner to the API stream, an ion detector capable of detecting a molecule of interest, and a control device.

Also disclosed is a method for detecting a chemical of interest in a liquid sample. The method includes providing a liquid sample in a continuous manner, ionizing the liquid sample in an API stream and analyzing the ionized sample.

Also disclosed is a method for detecting a chemical of interest in a liquid sample. The method includes introducing a liquid sample in a continuous manner into an API stream through a wicking agent and analyzing ionized sample for the chemical of interest using mass spectrometry.

### DETAILED DESCRIPTION OF DRAWINGS

The above-mentioned and other features and advantages of this invention, and the manner of attaining them, will become more apparent and the invention will be better understood by reference to the following description of embodiments of the invention taken in conjunction with the accompanying drawings, wherein corresponding reference characters indicate corresponding parts throughout the several views and wherein:

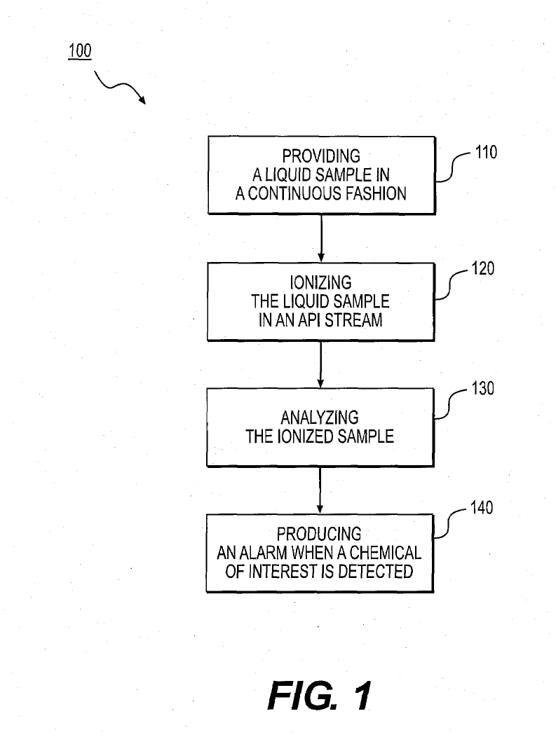

FIG. 1 is a flow chart showing a method for detecting a chemical of interest in a fluid sample.

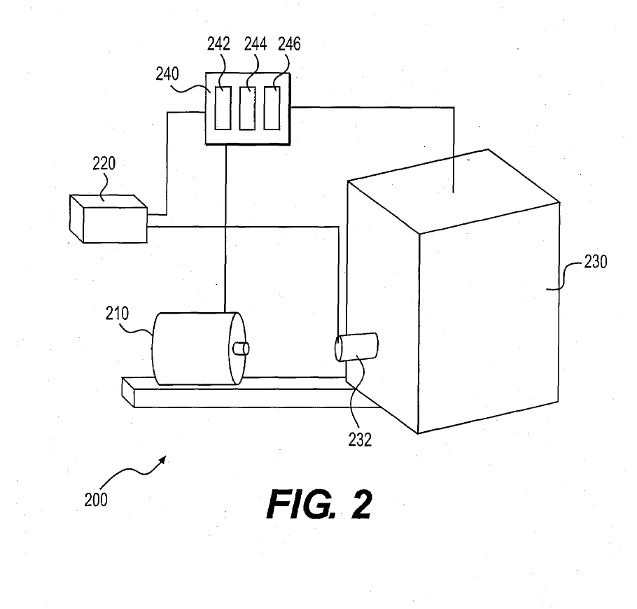

FIG. 2 depicts an embodiment of a Atmospheric Pressure Ionization (API) Technique-based detection system.

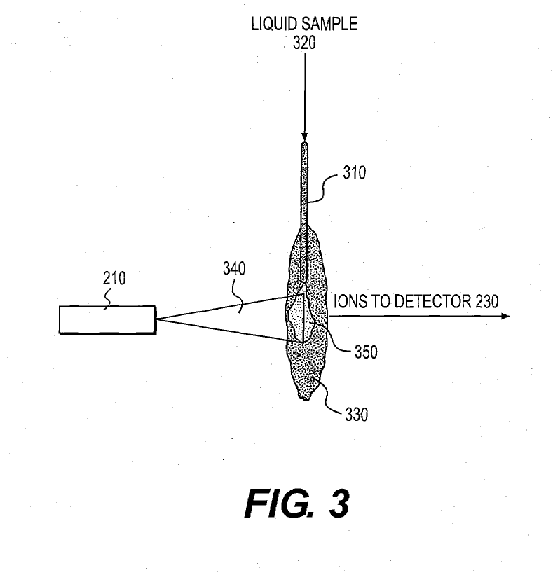

FIG. 3. API interrogating liquid sample distributed onto wicking agent from capillary tube inlet.

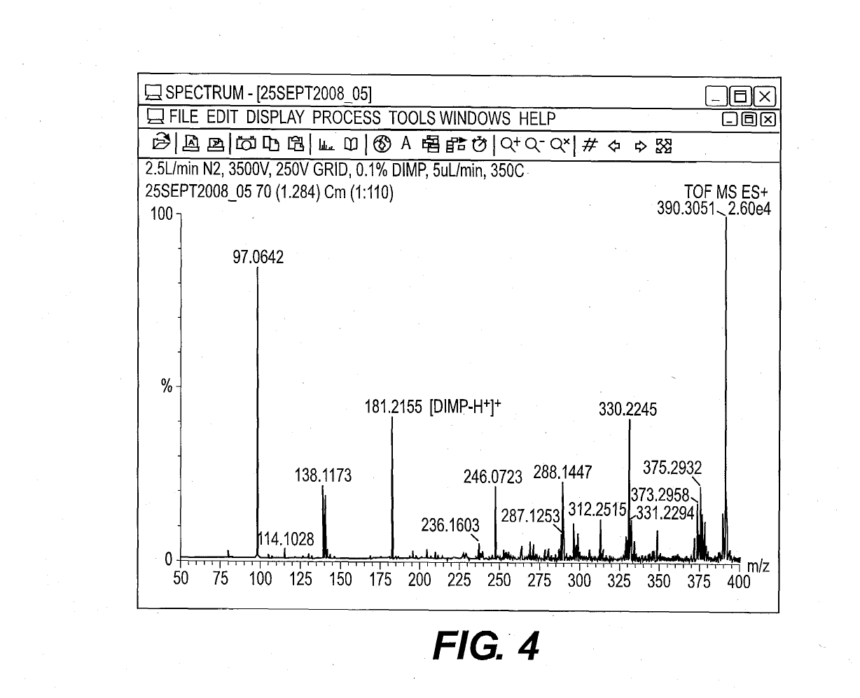

FIG. 4 is a diagram showing DART-MS detection of diisopropyl methylphosphonate (DIMP) in methanol

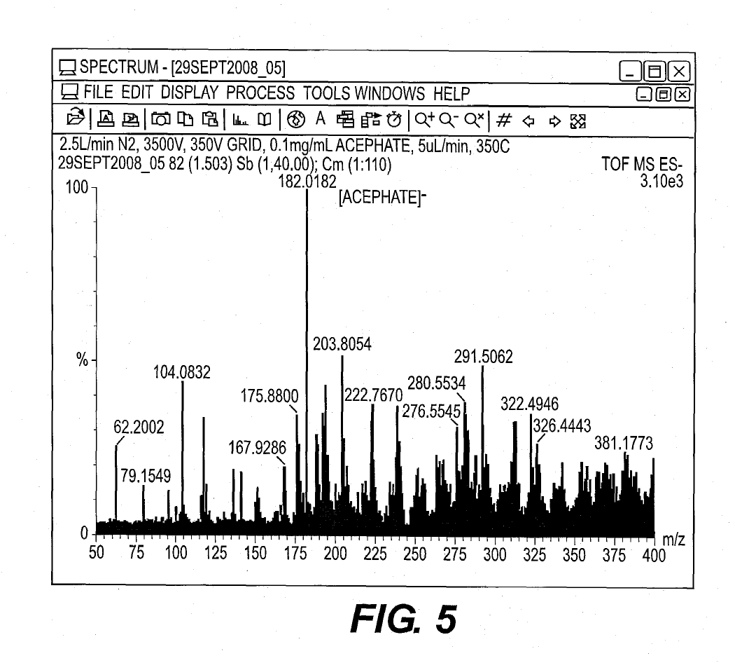

FIG. 5 is a diagram showing DART-MS detection of acephate in methanol

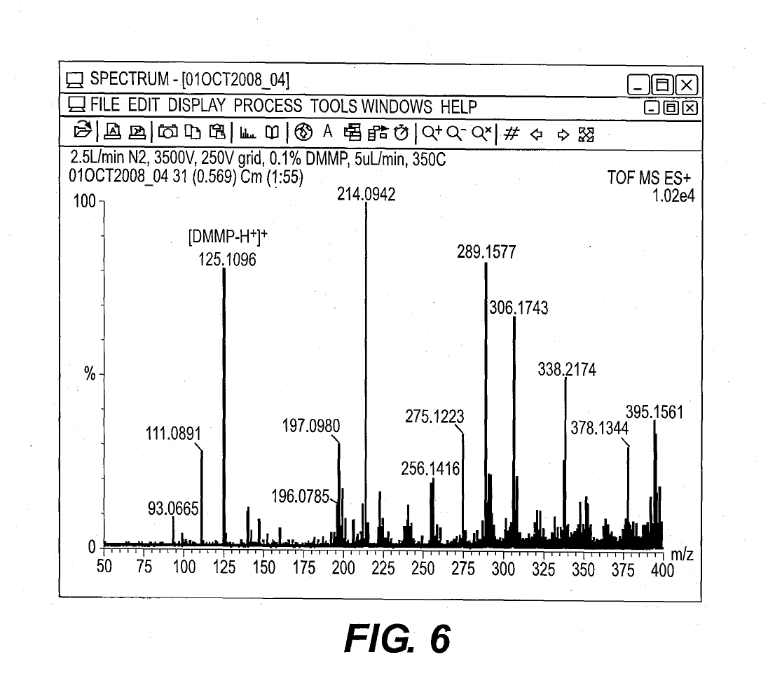

FIG. 6 is a diagram showing DART-MS detection of dimethyl methylphosphonate (DMMP) in methanol

### DETAILED DESCRIPTION

One aspect of the subject matter described herein relates to a method for detecting a chemical of interest in a fluid sample using an atmospheric pressure ionization (API)/detection system. Referring now to FIG. 1, an embodiment of the method 100 includes providing (110) a liquid sample in a continuous manner, ionizing (120) the liquid sample in an API stream produced by an API source, analyzing (130) the ionized sample, and producing (140) an alarm when a chemical of interest is detected. Examples of the API sources include, but are not limited to, Direct Analysis in Real Time (DART) ionization sources, Plasma Assisted Desorption/Ionization (PADI) sources, Desorption Electrospray Ionization (DESI) sources, Desorption Atmospheric Pressure Chemical Ionization (DAPCI) sources, Electrospray-assisted Laser Desorption/Ionization (ELDI) sources, Desorption Sonic Spray Ionization (DeSSI) sources and Desorption Atmospheric Pressure Photoionization (DAPPI) sources.

The liquid sample may be any liquid that may contain a chemical of interest. Examples of the liquid sample include, but are not limited to, natural water samples, potable water samples, petroleum product samples, and oil samples, samples from aerosol collection devices such as wet cyclone collectors, and samples in other types of solvents including transformer oils, lubricants (POLs), and other liquid media.

The chemical of interest may be any chemical molecule that can be ionized by API techniques. Examples of such chemicals of interest include, but are not limited to, chemical warfare agents (CWA), non-traditional agents (NTAs), dusty agents (DAs), toxic industrial chemicals (TICs), pharmaceuticals, metabolites, pesticides, peptides, oligosaccharides, drugs of abuse, explosives and their related compounds, and residues thereof.

Examples of CWAs include, but are not limited to, nerve agents such as GA (Tabun, ethyl N,N-dimethyl phosphoramidocyanidate), GB (Sarin, isopropyl-methylphosphorofluoridate), GD (Soman, Trimethylpropylmethylphosphorofluoridate), GF (cyclohexyl-methylphosphorofluoridate) and VX (o-ethyl S-[2-(diiospropylamino)ethyl]methylphosphorofluoridate); vesicants such as HD (mustard, bis-2-chlorethyl sulfide), CX (Phosgene oxime, dichloroformoxime), and L (Lewisite, J-chlorovinyldichloroarsine); cyanides such as AC (Hydrocyanic acid) and CK (Cyanogen chloride); pulmonary agents such as CG (phosgene, carbonyl chloride) and DP (Diphosgene, trichloromethylchlorformate).

NTAs and DAs are CWAs dispersed as either a liquid or particulate aerosol. For example, dusty mustard is composed of mustard agent (liquid) dispersed onto fine particulates of silica.

Examples of TICs can be found in the U.S. Environmental Protection Agency's reference list of toxic compounds (Alphabetical Order List of Extremely Hazardous Substances” Section 302 of EPCRA).

Examples of explosives detectable by the embodiments described herein include, but are not limited to, nitroglycerin-based powders, ammonium nitrate/fuel oil mixtures (ANFO), Trinitrotoluene (TNT), Pentaerythritoltetranitrate (PETN), Cyclotrimethylenetrinitramine (RDX), and Cyclotetramethylene-tetranitramine (HMX). Explosive related compounds include, but are not limited to, residual raw materials, manufacturing byproducts and degradation products.

The term “residue,” as used in the embodiments described herein, refers to a small amount of a substance, or a material associated with that substance. A residue may not directly be the substance whose detection is desired, but may be a substance indicative of the presence of the substance whose detection is desired. For example, a residue of a chemical agent may be a degradation product of the chemical agent, a chemical binder used to particulate a gaseous CWA, or a substrate on which a CWA is ordinarily placed.

The liquid sample may be delivered to an API source continuously over a period of time. In certain embodiments, the liquid sample may be delivered continuously over a short period of time, such as a few seconds to a few minutes, by a syringe pump. In other embodiments, the liquid sample may be delivered continuously over an extended period of time, such as a few minutes, a few hours, a few days or even a few weeks, by a peristaltic pump. The rate of delivery may be optimized based on the characteristics of the API source and detection technology. In certain embodiments, the liquid sample is delivered to the API source at a rate of 0.1-100 μl/min, 0.5-50 μl/min, 2-20 μl/min or 4-10 μl/min.

In one embodiment, the API source is a DART ionization source. Direct Analysis in Real Time (DART), generates a dry gas stream, such as helium or nitrogen, that contains long-lived electronically or vibronically excited neutral atoms or molecules (or “metastables”). The metastables are formed in the DART source by flowing the gas stream through a discharge chamber in which an electrical discharge produced atoms or molecules in excited state.

The excited-state species then interact directly with the chemical species in the sample liquid to ionize the chemical species. This process is referred to as Penning ionization, a reaction between an excited-state neutral atom or molecule M* and a substrate S that has an ionization potential with a lower energy than the internal energy of the excited-state species, resulting in the formation of a substrate radical molecular cation S⁺ and an electron e⁻:

M*+S→S⁺+e⁻

In negative-ion mode, electrons e⁻ are thermalized by collisions with gas molecules, G. Atmospheric oxygen captures an electron and reacts with the sample to produce negative ions.

e⁻+G→e⁻+G*

e⁻+O₂→e⁻+O₂⁻*

O₂⁻*S→[S—H]⁻+OOH*

The DART gas stream enhances chemical vaporization for more efficient ionization resulting in greater sensitivity.

In another embodiment, the API source is a DESI source. DESI is carried out by directing pneumatically assisted electrosprayed charged droplets onto the sample at atmospheric conditions. The charged droplets pick up the chemicals in the sample and then form highly charged ions that can be analyzed by an ion detector. The contents of the solvent spray, the gas flow rate, the amount of applied voltage, the spray angle and the ion uptake angle, as well as the various distances in aligning the spray, sample and the ion analyzer are all variables which can be studied to achieve an optimal spectrum for a particular type of chemical. A wide range of molecules, including explosives and chemical warfare agents, have been successfully ionized using DESI.

In another embodiment, the API source is a PADI source. Similar to DART, PADI also uses a plasma for ionization but there are several crucial differences. The DART plasma is formed by a glow discharge held away from the liquid sample. Charged species are removed to leave a beam of metastable species to hit the-sample. In contrast, PADI employs an atmospheric glow discharge which is held in direct contact with the sample. The ions formed in this plasma are far less energetic than those in the DART discharge and are allowed to remain in the plasma. The reduced energy means that the plasma does not heat the sample, so thermally sensitive chemicals can be studied.

In another embodiment, the API source is a DAPCI source. DAPCI uses a flow of solvent vapor and a corona discharge to affect ionization. With atmospheric solids analysis probe (ASAP), a jet of heated gas is directed at the sample to ionize the chemical(s) in the sample by corona discharge.

In another embodiment, the API source is a ELDI source that uses laser to ionize the sample.

In another embodiment, the API source is a DeSSI source that uses sonic spray to ionize the sample.

In another embodiment, the API source is a DAPPI source that uses a jet of heated solvent and ultraviolet light to ionize the sample.

The ionized chemicals can be analyzed using a number of charged ion detection technologies. Examples of ion detection technologies include, but are not limited to, mass spectrometers with different mass analyzers (such as quadrupole, time of flight, ion trap, etc), ion mobility spectrometers, and differential ion mobility spectrometers and tandem techniques such as ion mobility spectrometry-mass spectrometry.

FIG. 2 depicts an embodiment of an API-based detection system 200 for detection of analyte in solution. The system 200 includes an API source 210 that produces an ionization stream (i.e., an API stream), a sample delivery system 220 that delivers a liquid sample to the API stream, and an ion detector 230 having a ion inlet 232. This approach is unique because it provides rapid, real time monitoring of contaminants in a liquid with little or no pretreatment of the sample.

The API source 210 can be any of the known API sources, including but are not limited to, DART ionization sources, DESI, PADI, DAPCI, ELDI, DeSSI and DAPPI sources. A DART source 210 provides the atmospheric ionization capability and its associated rapid production of specific ions of an analyte to analyze for materials dissolved or dispersed in a solvent in real time. In certain embodiments, the DART source uses nitrogen as the carrier gas in the ionizing stream. The nitrogen may be produced by a portable nitrogen generator so that the system 200 is operable in the field without the need for a carrier gas tank, thus reducing logistics and lifetime costs. In one embodiment, the nitrogen has a purity of 80% (v/v) to 99.999% (v/v).

The sample delivery system 220 may contain a sample reservoir and a liquid sample delivery device. The liquid sample delivery device can be any device, such as pumps or syringes, that is capable of delivering a liquid sample at a desired flow rate. In one embodiment, the sample delivery system 220 contains a syringe pump. In another embodiment, the sample delivery system 220 contains a peristaltic pump. The sample delivery system 220 is capable of delivery a liquid sample to the ionizing stream at a desired rate in a batch fashion or in a continuous fashion. In one embodiment, the liquid sample is delivered to the ionizing stream through a delivery tube. The delivery tube can be a capillary tube made of glass or plastics. In one embodiment, the tip of the delivery tube is located within the API stream such that the signal is optimized for largest response. In another embodiment, the tip of the delivery tube is located outside the API stream. The liquid sample is introduced into the ionization stream as a droplet or atomized spray. Once inside the ionization stream, the solvent of the liquid sample is volatilized by the API carrier gas with subsequent ionization of the analyte(s) contained within the liquid. There is significant evidence that metastable ions are also capable of directly ionizing low vapor pressure compounds at temperatures well below boiling point. The ionized sample is then transferred into the ion detector 230 for detection and analysis.

In certain embodiments, the liquid sample is introduced into the API stream at the end of a capillary tube as droplets of liquid. In certain other embodiments, a wicking agent is placed at the end of the capillary tube to improve the distribution of the liquid sample in the API stream. The wicking agent can be a metal screen, a wire, a fibrous material such as carbon fibers or fabric, a polymeric screen, or an absorptive material. The metal screen or wire may be further covered with an absorptive material.

Examples of the absorptive material include, but are not limited to, porous polymer resins, liquid polymers, sorbent carbons, nanotube materials, cellulose based materials, inorganic based sorbents and combinations thereof.

Examples of porous polymer resins include, but are not limited to, Tenax® (2,6-diphenylene oxide), PIB (poly(isobutylene)), SXPH (75% phenyl-25% methylpolysiloxane), PEM (polyethylene maleate), SXCN (poly bis(cyanopropyl) siloxane), PVTD (poly (vinyltetradecanal)), PECH (poly(epichlorohydrin)), PVPR (poly(vinyl propionate)), OV202 (poly(trifluoropropyl) methyl siloxane), P4V (poly(4-vinylhexafluorocumyl alcohol)), SXFA (1-(4-hydroxy, 4-trifluoromethyl,5,5,5-trifluoro) pentene methylpolysiloxane), FPOL (fluoropolyol), PEI (poly(ethyleneimine), SXPYR (alkylaminopyridyl-substituted siloxane), and polysilsesquioxane. In one embodiment, the sorbent material is Tenax®.

Examples of liquid polymers include, but are not limited to, polydimethylsiloxane (PDMS).

Examples of sorbent carbons include, but are not limited to, activated carbon, charcoal, carbon molecular sieves, graphtized carbon blacks, and graphite.

Examples of the inorganic based sorbents include, but are not limited to, zeolites, metal organic frameworks (MOFs), and ionic liquids. Zeolites are hydrated aluminosilicate minerals with a micro-porous structure. MOFs are porous polymeric materials, consisting of metal ions linked together by organic bridging ligands to form one-, two-, or three-dimensional porous structures.

Examples of the nanotube materials include, but are not limited to, single, double or multi-walled carbon nanotubes, derivatized single, double or multi-walled carbon nanotubes, and carbon nanotube product such as nanotube paper. The term “nanotube,” as used in the embodiments described herein, refers to a hollow article having a narrow dimension (diameter) of about 1-200 nm and a long dimension (length), where the ratio of the long dimension to the narrow dimension, i.e., the aspect ratio, is at least 5. In general, the aspect ratio is between 10 and 2000. The term “carbon-based nanotubes” or “carbon nanotubes,” as used hereinafter, refers to nanotube structures composed primarily of carbon atoms. The “carbon-based nanotube” or “carbon nanotubes,” includes derivatized carbon nanotubes and carbon nanotubes doped with other elements, such as metals. The term “carbon nanotube product,” as used hereinafter, refers to cylindrical structures made of rolled-up graphene sheet, either single-wall carbon nanotubes or multi-wall carbon nanotubes.

The wicking agent, which allows for transmission of the API stream through it to the ion detector 230, collects the liquid sample and distributes it over a larger surface area than the original droplet in the API stream. A diagram of the orientation and use of the wicking agent with the API source is shown in FIG. 3. In this embodiment, the capillary tube 310 delivers the liquid sample 320 onto the wicking agent 330 at a position outside the API stream 340. The liquid spreads over the wicking agent 330 into the API 340 as a uniform film 350 which exposes more of the analyte to the API region than if a single droplet is introduced into the API stream. The wicking agent 330 will also facilitate more rapid vaporization of higher boiling solvents (such as water) and generating more analyte ions because of the rapid removal of the solvent resulting in greater sensitivity.

The ion detector 230 can be a mass spectrometer or other ion detection devices. In one embodiment, the ion detector 230 is a mass spectrometer. The distance between the API source 210 and the inlet 232 of the mass spectrometer is 1-100 mm, 2-50 mm, or 5-25 mm. The ions formed are directed to the mass spectrometer inlet 232 by both the gas flow and a slight vacuum in the spectrometer inlet 232.

The system 200 may further include a control device 240. The control device 240 provides coordination and communication of the components in the system 200. The control device 240 is designed to: (a) provide a single user interface to the entire system 200; (b) allow a user to quickly determine the status of all components associated with the system; and (c) accept input to change parameters which allow for the configuration changes, and (d) indicate detection of a chemical of interest and produce an alarm. At its most basic level, the control device 240 provides an alarm when a target chemical is identified by the ion detector 230.

In one embodiment, the control device 240 includes a memory 242, a controller 244, and an external port 246. The memory 242 may be used to store libraries of signature fingerprints of chemicals and operation software. In one embodiment, the memory 242 is a flash memory. The controller 244 monitors and controls the operation of the API source 210, the sample delivery system 220, the ion detector 230 and provides an interface to the user about the status of the overall system. For example, the controller 244 may stage the sample delivery rate of the sample delivery system 220, and compare the results from the ion detector 230 with the libraries of fingerprint of chemicals in the memory 242 to identify the target chemical and reduce false positives.

In one embodiment, the controller 244 is small, lightweight and available as a standard commercial off-the-shelf (COTS) product. In another embodiment, the controller 244 is a COTS offering and is packaged as a microbox PC with a passive PCI bus backplane. This configuration allows the component modularity for easy upgrades as computer hardware technologies improve. In another embodiment, the controller 244 resides on a single board computer (SBC) that already have its peripheral interfaces built in: PCI bus, Ethernet, and RS-232 serial. Flash memory and DRAM can be sized to the control system requirements with removable memory sockets on the SBC. Communication from the controller 244 to the other components of the system 200 is handled by COTS data acquisition, digital input/output, and analog input/output circuit cards that are PCI bus compatible.

The external port 246 is used for downloading software upgrades to the memory 242 and performing external trouble-shooting/diagnostics. In one embodiment, the system 200 is powered by a long-life battery or batteries that can be recharged and reused. Preferably, the batteries are interchangeable with batteries from other Northrop Grumman portable systems.

In another embodiment, field-programmable gate array (FPGA) technology is used for monitors and control circuits in order to keep the weight, size, and especially power consumption at a minimum. The FPGA technology also affords minimum hardware redesign impact when implementing system upgrades.

### EXAMPLES

The following specific examples are intended to illustrate the collection and detection of representative chemicals using methods and devices described in the embodiments. The examples should not be construed as limiting the scope of the claims.

### Example 1

### DART/MS Analysis of DIMP, Dibutyl Amine, Aniline and Methamidophos

The detection limits of the DART/MS technique for analytes in a liquid was evaluated. A prototype system similar to that described in FIG. 2 was set-up. Liquid samples are introduced into the DART stream with a Harvard syringe pump connected to a short (˜6 cm) capillary which was mounted in a fixed position in the DART stream throughout the experiment. Each sample was loaded into a Hamilton 1 ml syringe and the sample injected into the DART stream at a rate of 5 μl/min. For each analyte a series of dilutions were prepared in HPLC grade methanol. Calibration curves were generated by measuring the signal intensity for a particular analyte in solution at five different concentrations and a calibration equation generated by fitting the data to a linear equation. The sample is introduced at the end of a capillary tube as a droplet of liquid. Detection limits for each analyte were determined using the calibration equation and solving for the concentration equivalent to the sum of the average noise at an analytes mass and 3 times the standard deviation of the noise. Detection limits are given in Table 1 below for the four analytes tested. The analytes were chosen because they are acceptable simulants for toxic materials that cannot be used in laboratory: DMMP—Nerve Agent, Dibutyl Amine, Aniline—toxic industrial chemical (TIC), methamidophos—Low Vapor Pressure Chemical/Non-Traditional Chemical Agent

TABLE 1
Detection Limits of Analytes in Methanol Using DART-MS

| Analyte | Detection Limit (ppb) |
|---|---|
| DMMP | 0.53 |
| Dibutyl Amine | 0.05 |
| Aniline | 2.06 |
| Methamidophos | 3.92 |

The results of experiments in Table 1 demonstrate that the DART is capable of detecting part-per-billion (ppb) to part-per-trillion (ppt) levels of the specific analytes tested. FIGS. 4-6 are mass spectrographs showing detection of DIMP, acephate and DMMP, respectively, in methanol. FIG. 4 shows the mass spectrograph of the nerve agent simulant, diisopropyl methylphosphonate (DIMP) in methanol at a concentration of 0.1%. The protonated species, [DIMP-H⁺]⁺, is evident as a peak at 181.2 m/z. In FIG. 5 the mass spectrograph for the non-traditional chemical agent simulant acephate at a concentration of 0.1 mg/ml exhibits the acephate peak at 182.0 m/z. FIG. 6 shows the mass spectrograph of the nerve agent simulant dimethyl methylphosphonate (DMMP) with its characteristic peak at 125.1 m/z.

The foregoing discussion discloses and describes many exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A chemical detection system, comprising:
an atmospheric pressure ionization (API) source that produces an API stream;
a sample delivery system that delivers a liquid sample in a continuous manner to the API stream;
an ion detector capable of detecting a molecule of interest; and
a control device.

2. The system of claim 1, wherein the API source is a direct analysis in real time (DART) ionization source.

3. The system of claim 1, wherein the API source uses nitrogen as carrier gas.

4. The system of claim 1, further comprising a nitrogen generation device.

5. The system of claim 1, wherein the sample delivery system comprises a pump capable of delivering the liquid sample into the API stream.

6. The system of claim 1, wherein the sample delivery system comprises a capillary tube with an open end, wherein the open end is placed inside the API stream.

7. The system of claim 1, wherein the sample delivery system comprises a capillary tube with an open end, wherein the open end is placed outside the API stream.

8. The system of claim 1, wherein the sample delivery system comprises a capillary tube and a wicking agent placed at a tip of the capillary tube, wherein the wicking agent is placed inside the API stream.

9. The system of claim 8, wherein the wicking agent is selected from the group consisting of metal or polymeric screens, wires, fibrous materials, fabrics, polymeric materials, absorptive materials, and combinations thereof.

10. The system of claim 9, wherein the absorptive material is selected from the group consisting of porous polymer resins, liquid polymers, sorbent carbons, nanotube materials, cellulose based materials, inorganic based sorbents and combinations thereof.

11. The system of claim 1, wherein said ion detector detects ions using a technique selected from the group consisting of mass spectrometry (MS), ion mobility spectrometry (IMS), differential ion mobility spectrometry (DMS) and combinations thereof.

12. The system of claim 11, wherein said mass spectrometry is selected from the group consisting of quadrupole mass spectrometry, time of flight mass spectrometry, ion trap mass spectrometry, Quadrapole Ion Trap Time Of Flight (QitTOF) mass spectrometry, Fourier Transform Ion Cyclotron Resonance mass spectrometry and magnetic sector mass spectrometry or any hybrid/tandem combinations of the above.

13. The system of claim 1, wherein said control device comprises:
a memory for storing signature fingerprints of chemicals and operation software;
a controller that provides a user interface; and
an external port.

14. A method for detecting a chemical of interest in a liquid sample, comprising:
providing a liquid sample in a continuous manner;
ionizing the liquid sample in an API stream; and
analyzing the ionized sample.

15. The method of claim 14, further comprising:
producing an alarm when the chemical of interest is detected.

16. The method of claim 14, wherein the API stream uses nitrogen as carrier gas.

17. The method of claim 14, wherein the liquid sample is provided by a syringe pump or a peristaltic pump.

18. The method of claim 14, wherein the liquid sample is provided continuously into the API stream through a wicking agent, wherein the wicking agent the wicking agent is selected from the group consisting of metal screens, wires, fibrous materials, absorptive materials, and combinations thereof, and wherein the wicking agent is placed inside the API stream.

19. The method of claim 14, wherein the ionized sample is analyzed by mass spectrometry.

20. A method for detecting a chemical of interest in a liquid sample, comprising:
introducing a liquid sample in a continuous manner into an API stream through a wicking agent; and
analyzing ionized sample for the chemical of interest using mass spectrometry.
